(19) United States
(12) Patent Application Publication
(10) Pub. No.: US 2008/0081211 A1
(43) Pub. Date: Apr. 3, 2008

(54) EASY-TO-CLEAN COOKING SURFACE AND ELECTRICAL HOUSEHOLD APPLIANCE COMPRISING SUCH A SURFACE

(75) Inventors: Stephane Tuffe, Congnin (FR); Alain Coudurier, Albens (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 11/856,545

(22) Filed: Sep. 17, 2007

Related U.S. Application Data
(63) Continuation-in-part of application No. PCT/FR2006/000360, filed on Feb. 16, 2006.

(30) Foreign Application Priority Data
Mar. 15, 2005 (FR) 0502540

(51) Int. Cl. B32B 15/00; B32B 15/18; B32B 15/20

(52) U.S. Cl. 428/650; 428/668; 428/674; 428/681; 428/684; 428/685

(57) ABSTRACT

Food cooking surface for a kitchen utensil or cooking appliance, constituted by the surface of a compound fabricated starting from an alloy whose two principal components are zirconium and cobalt.

### CROSS-REFERENCE TO RELATED APPLICATION

This is a continuation-in-part of International Application PCT/FR2006/000360, filed Feb. 16, 2006, the disclosure of which is incorporated herein by reference.

### BACKGROUND OF THE INVENTION

The present invention relates to the field of articles intended for the preparation and the cooking of food and more particularly the cooking surface of these articles in contact with food to be treated.

For many years, great efforts have been developed in order to facilitate the daily preparation of meals. Among the notable progress, coatings containing fluorocarbonated polymers as a non-stick coating in kitchen utensils quickly developed since the end of 1950. Such coatings are universally known since the process presented in the patent FR 1120749 allowed a sure fixing of such coatings on various metals, such as aluminum.

However, such coatings remain fragile and resist scratching poorly. Thus, clever ways were developed in order to mechanically reinforce the layer on its support. Numerous improvement patents describe methods and means making it possible to increase the scratch resistance of such coatings, by acting on the coating and/or the substrate. Despite everything, such coatings remain sensitive to the repeated use of sharpened or pointed metallic materials, such as knives or forks.

In parallel, developments were carried out on mechanically resistant surfaces on which attempts were made to improve the ease of cleaning. Deposits of metal, such as chrome plating on stainless steel, quasi-crystals, or nonmetals (silicates, . . . ) thus appeared. The results remain however disappointing, in particular in comparison with coatings of the PTFE type.

There is also known, from the document FR 2 848 797, a cooking surface composed in major part of metallic zirconium, surface which has a very good hardness, since the layer is nitrided or carburized, presenting satisfactory ease of cleaning but without attaining the ease of cleaning of layers of the PTFE type.

### BRIEF SUMMARY OF THE INVENTION

The present invention aims at remedying the above mentioned disadvantages of the prior art, by proposing a cooking surface with improved ease of cleaning characteristics, durably presenting a reduction of the adherence of food during cooking, corrosion resistance, while having a good mechanical resistance, and in particular a high hardness.

The present invention is achieved by a food cooking surface for a kitchen utensil or cooking appliance, characterized in that this cooking surface is a compound developed starting from an alloy whose two principal components are zirconium and cobalt.

### DETAILED DESCRIPTION OF INVENTION

Metal alloys containing cobalt are known for their good wear resistance.

Surprisingly, it has been noted, during tests, that alloys, based on cobalt and zirconium, also presented properties of ease of cleaning when such surfaces were used as a cooking surface and when foodstuffs remained attached to the surface, for example after a calcination of the cooked products. This ease of cleaning can be expressed by the possibility of easily removing elements carbonized on the cooking surface.

This ease of cleaning is completed, at the time of production of the compound, by an increase in hardness of said compound.

Moreover, the use of zirconium makes it possible to obtain very varied colors of the coating, which it is not possible to obtain only with cobalt. It is then possible to define a coating color making it possible to identify clearly, for the user, that the coating used is specific and corresponds to an “easy to clean” coating. One can even envision connecting the various colors to the results of the tests of ease of cleaning of cooking surfaces according to the food, so that this color code makes it possible for users to easily identify the good cooking surface for cooking a given type of food (eggs, fish, meat, . . . ).

Advantageously, the alloy essentially contains zirconium, cobalt and chromium. Chromium and cobalt alloys, such Alacrite®, are generally known for their exceptional resistance to corrosion (primarily by chromium), and their good wear resistance (primarily by cobalt). They are primarily used, in mechanics, for interior lining of piston bearings. Certain slight differences are used in the medical field for the fabrication of implants and prostheses.

The presence of chromium thus makes it possible to reinforce the resistance of the cooking surface to chemical agents and corrosion.

The development of the cooking surface has a step of deposition of the components, in an appropriate thickness, on a substrate, followed by a nitriding of the components. Such a nitriding, primarily of the zirconium, makes it possible to increase considerably the hardness of the cooking surface, while bringing diversity to the colors obtained, primarily by exploiting the stoichiometry of zirconium nitride.

Advantageously, the development of said surface has a step of carburization or carbonitriding of the surface after the stage of nitriding, making it possible to further increase the surface hardness of the layer, to make it almost insensitive to scratching, without altering its ease of cleaning properties. In addition, the nitriding step allows a good adherence of the carbide or carbonitride layer of Co/Cr/Zr. It is indeed known in addition, that it is very difficult to cause a layer of carbide or carbonitride to adhere to a substrate of the aluminum or stainless steel type without an intermediate layer. In addition, the deposition rate of a layer of carbide is definitely higher than the deposition rate of a layer of nitride.

The gradient of the composition thus obtained combines the properties of ease of cleaning of Co/Cr alloy surfaces with the high potential of hardening, of coloring and of corrosion resistance of the layers of nitride, carbide and carbonitride of zirconium. The hardnesses obtained can go up to 2500 Vickers for a zirconium carbide.

According to a preferred mode of preparation, the deposition of the components on a substrate will be a physical deposition in vapor phase from one or several massive targets. In this latter case the target can be obtained by assembly on a copper substrate of one or more sheets or plates of material having the desired composition, said sheets or plates being obtained either by powder sintering or thermal projection of powder, or resulting from casting. These targets thus constitute the source of the materials that will be deposited on the cooking surface. Generally, all the techniques of physical deposition in vapor phase can be used.

This implementation has the advantage of using little material and of being able to adjust a small thickness of material on the substrate in order to produce the cooking surface. This deposition technique makes it possible, in addition, to obtain deposits in strong cohesion with the substrate on which they are deposited. The risks of separation of the deposit during use are thus minimized.

The substrate can be composed of one or more metal sheets of following materials: aluminum, stainless steel, cast iron, steel, copper.

Other advantages resulting from tests will appear from a reading of the description that will follow, relating to an illustrative example of the present invention given as a nonlimiting example.

The various examples of realization of the invention relate to a deposition, on a stainless steel substrate, by PVD, of a Co/Zr alloy by using the four eutectic points of the binary diagram of Co/Zr. The percentage, in weight, of zirconium, for these four eutectics, is thus 14%, 57.5%, 74% and 85%. One face of this deposit has undergone a mechanical surface treatment, before the performance of tests, in order to make it similar to other cooking surfaces so that the tests of evaluation of the ease of cleaning such a surface, in a domestic cooking use, can be compared. The deposited thickness is of the order of several microns, e.g. 3-4 microns.

After deposition of the components, the layer underwent a nitriding, then a carbonitriding. The longer the phase of carbonitriding, the more the surface will be hard.

The system for evaluation of the ease of cleaning makes it possible to quantify the capacities of a cooking surface to return its original appearance after use. This system of evaluation comprises the following steps:
the surface is locally covered with a food mixture of known composition,
this mixture is carbonized in a furnace under defined conditions, for example 210° C. during 20 minutes,
after cooling, the surface is put to soak for a controlled time in a mixture of water and detergent,
an abrasive pad is then applied under a defined constraint using an apparatus to abrade (plynometer) the soiled surface in a back and forth movement during a given number of cycles,
the percentage of the correctly cleaned surface is noted and characterizes the ease of cleaning of the cooking surface.

The tests carried out on various types of surface thus make it possible to comparatively evaluate the quality of the surfaces as regards their ease of cleaning. Of course, the tests are carried out by respecting the same parameters for each step of the system of evaluation: the same food mixture, the same surface of application of the food mixture, the same temperature of carbonization, . . . .

The following comparative table shows the results obtained on three different cooking surfaces, namely polished stainless steel, quasi-crystals, and the cobalt/zirconium alloy according to one of eutectics cited, deposited on stainless steel, nitrided then carbonitrided, as previously described, after polishing, in a severe test with a food composition containing milk and rice considered to be difficult to clean once carbonized. Such a test thus makes it possible to highlight well the differences between quality of cleaning of the surfaces.

| | Polished | | Co/Zr alloy |
|---|---|---|---|
| | stainless | Quasi- | nitrided/carbonitrided |
| | steel | crystals | on stainless steel |
| Quantity of carbonized | 50% | 60% | 90% |
| residue removed | | | |

The table shows without ambiguity the very favorable results obtained with the Co/Zr alloy deposited on stainless steel, and in particular the results compared with other cooking surfaces. Other tests carried out on an aluminum base show similar results. The ease of cleaning for an alloy according to the invention, as set forth in the table above, is substantially the same for any of the eutectic composition percentages cited earlier herein.

It should be noted that the number of cycles of abrasion on the plynometer was fixed at 18. This reduced number of cycles highlights well the quality of ease of cleaning of the surface according to the invention since there remains not more than 10% of the surface soiled after 18 back and forth passes of the abrasive pad.

Repetitive tests after complete cleaning of the surface show that the ease of cleaning of the alloy presented is not altered.

When the implementation of the invention implies the use of a substrate, this latter is then composed of one or more metal sheets of the following materials: aluminum, stainless steel, cast iron, steel, copper.

According to certain preferred embodiments, the compound, or ally, according to the invention could be composed of 50% to 90% Zr, with the balance being Co or Co and Cr. Nitriding can be performed with N₂ as the reactant and carbonitriding can be performed with N₂+CH₄ or C₂H₂ gas as the reactant, the reactant preferably being in a stoichiometric quantity.

Typically, the PVD process is carried out at low pressure, equal to or less than 1 Pa, and at a temperature in the range of 100° C. to 300° C. Higher temperatures may be employed, for example to modify the microstructure of the layer forming the cooking surface, for example to reduce porosity.

Layers providing cooking surfaces according to embodiments of the invention may include nitrides or carbonitrides of Zr, Co, Cr in the form of a binary or ternary alloy.

The conditions for fabricating a coating according to the present invention depend on the characteristics of the deposition apparatus employed and, for a given apparatus and given coating composition, can be readily determined by those skilled in the art.

What is claimed is:

1. Food cooking surface for a kitchen utensil or cooking appliance, characterized in that this cooking surface is a compound fabricated starting from an alloy whose two principal components are zirconium and cobalt.

2. Food cooking surface for a kitchen utensil or cooking appliance according to the preceding claim, characterized in that the three principal components of the alloy are zirconium, cobalt and chromium.

3. Food cooking surface for a kitchen utensil or cooking appliance according to one of the preceding claims, whose fabrication is characterized by a stage of nitriding of the alloy after deposition of the components, in an appropriate thickness, on a substrate.

4. Food cooking surface for a kitchen utensil or cooking appliance according to the preceding claim, characterized in that the fabrication of said surface comprises a step of carburization or carbonitriding of the surface after the step of nitriding.

5. Food cooking surface for a kitchen utensil or cooking appliance according to claim 3, characterized in that the deposition is carried out by physical deposition in vapur phase from one or several massive targets.

6. Food cooking surface for a kitchen utensil or cooking appliance according to the preceding claim, characterized in that the deposition is carried out starting from a target obtained by assembly on a copper substrate of one or more sheets or plates of material having the desired composition, said sheets or plates being obtained either by powder sintering or thermal powder projection, or resulting from casting.

7. Food cooking surface for a kitchen utensil or cooking appliance according to claim 3, characterized in that the substrate is composed of one or more metal sheets of the following materials: aluminum, stainless steel, cast iron, steel, copper.
